(19) United States
(12) Patent Application Publication
(10) Pub. No.: US 2015/0372561 A1
(43) Pub. Date: Dec. 24, 2015

(54) MOTORIZED SERVO DEVICE HAVING BEARING FOR SUPPORTING SPINDLE OF MOTOR

(71) Applicant: TRICORE CORPORATION, Huatan Township (TW)

(72) Inventor: Yen-Fu CHEN, Huatan Township (TW)

(21) Appl. No.: 14/528,227

(22) Filed: Oct. 30, 2014

(30) Foreign Application Priority Data
Jun. 20, 2014 (TW) 103211000

(51) Int. Cl. H02K 7/08; H02K 7/116

(52) U.S. Cl. CPC H02K 7/083; H02K 7/116

(57) ABSTRACT

A motorized servo device includes a case, a bearing and a motor. The case is provided with a top plate having a top surface and a bottom surface, an installing seat protruding from the top surface of the top plate, and an accommodating space located under the bottom surface of the top plate. The bearing is mounted in the installing seat of the case. The motor is disposed in the accommodating space and has a spindle penetrating through the top plate of the case and the bearing. As a result, the motorized servo device can output relatively higher power and has relatively higher structural reliability and motor accuracy, and simpler process of assembly.

### BACKGROUND OF THE INVENTION

1. Field of the Invention

The present invention relates generally to a motorized servo device which is so called servomotor. The present invention relates more particularly to a motorized servo device which has a motor built therein and a bearing for supporting the spindle of the motor. Therefore, the motorized servo device has high structural reliability, high motor accuracy and relatively simpler process of assembly.

2. Description of the Related Art

Referring to FIG. 1, a conventional motorized servo device 10 comprises a case 11, a cap 12 mounted on the top of the case 11, a motor 13 installed in the case 11, and a gear mechanism 14 and an output shaft 15, which are installed in the cap 12. The case 11 has a top plate 111 and an installing seat 112 protruding upwards from the top plate 111 and provided with a side opening. The motor 13, which is placed under the top plate 111, has a spindle 131 penetrating through the top plate 111, and an output gear 132 fixedly sleeved onto the spindle 131 and located in the installing seat 112. The rotational kinetic energy of the motor 13 is outputted by the output gear 132 and transmitted to the output shaft 15 through the gear mechanism 14.

The top end section of the spindle 131 penetrates through a bearing 16 which is fixedly mounted in the top plate 111 and capable of supporting the spindle 131, so that the rotor of the motor 13 has relatively higher coaxiality and therefore rotates more stably. For installation of the bearing 16, the top plate 111 is made relatively thicker, thereby decreasing the space designed for accommodating the motor 13 under the top plate 111. Therefore, the motor 13 of the motorized servo device 10 used in the conventional motorized servo device 10 is relatively smaller and thereby outputs relatively lower power. Besides, when the rotor of the motor 13 quakes during running, the bearing 16 is liable to be hit by the rotor and thereby separated from the top plate 111, so that the motorized servo device 10 has relatively lower structural reliability. In addition, the positional arrangement of the bearing 16 causes insufficient support to the spindle 131 and relatively more complicated process of assembling the motorized servo motor 10.

### SUMMARY OF THE INVENTION

The present invention has been accomplished in view of the above-noted circumstances. It is an objective of the present invention to provide a motorized servo device which has a bearing for supporting the spindle of the motor therein, can output higher power than the conventional motorized servo device under a condition of same volume, and has relatively higher structural reliability, higher motor accuracy and simpler process of assembly.

To attain the above objective, the present invention provides a motorized servo device which comprises a case, a bearing and a motor. The case is provided with a top plate having a top surface and a bottom surface, an installing seat protruding from the top surface of the top plate, and an accommodating space located under the bottom surface of the top plate. The bearing is mounted in the installing seat of the case. The motor is disposed in the accommodating space and has a spindle penetrating through the top plate of the case and the bearing.

As a result, the top plate of the case can be made relatively thinner because the bearing is not mounted in the top plate; in this case, the accommodating space is relatively larger and therefore the motor disposed therein can be also larger so that the motorized servo device can output higher power. Besides, the positional arrangement of the bearing causes relatively higher coaxiality to the rotor of the motor and therefore enhances the accuracy of the motor. In addition, the bearing will not hit by the rotor of the motor when the rotor quakes during running, so that the motorized servo device has relatively higher structural reliability. Furthermore, the installing seat of the case can be provided with an upward opening, through which the bearing enters the installing seat; in this case, the bearing can be easily installed in the installing seat so that the process of assembling the motorized servo device is simplified.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a partially cutaway view of a conventional motorized servo device according to a prior art;

FIG. 2 is an assembled perspective view of a motorized servo device according to a preferred embodiment of the present invention;

FIG. 3 is an exploded perspective view of the motorized servo device according to the preferred embodiment of the present invention; and

FIG. 4 is a sectional view of the motorized servo device according to the preferred embodiment of the present invention.

### DETAILED DESCRIPTION OF THE INVENTION

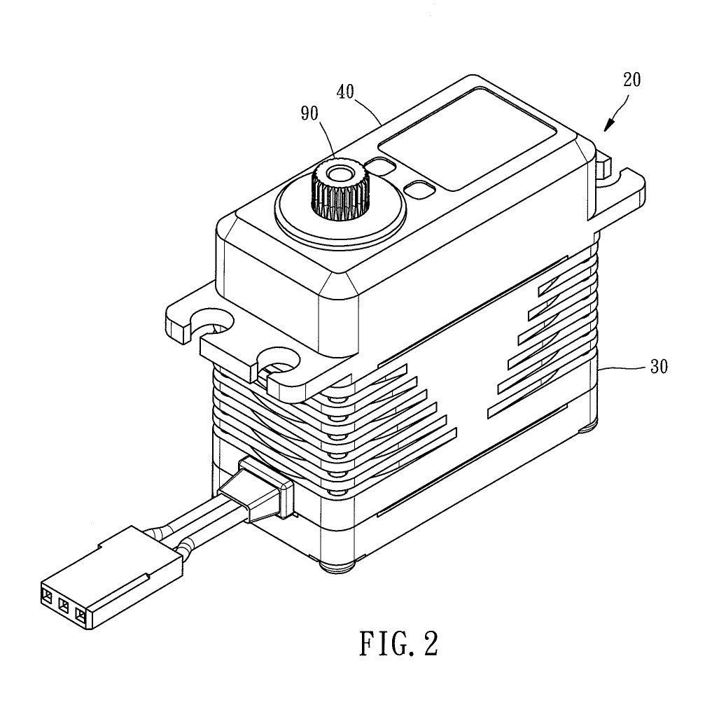

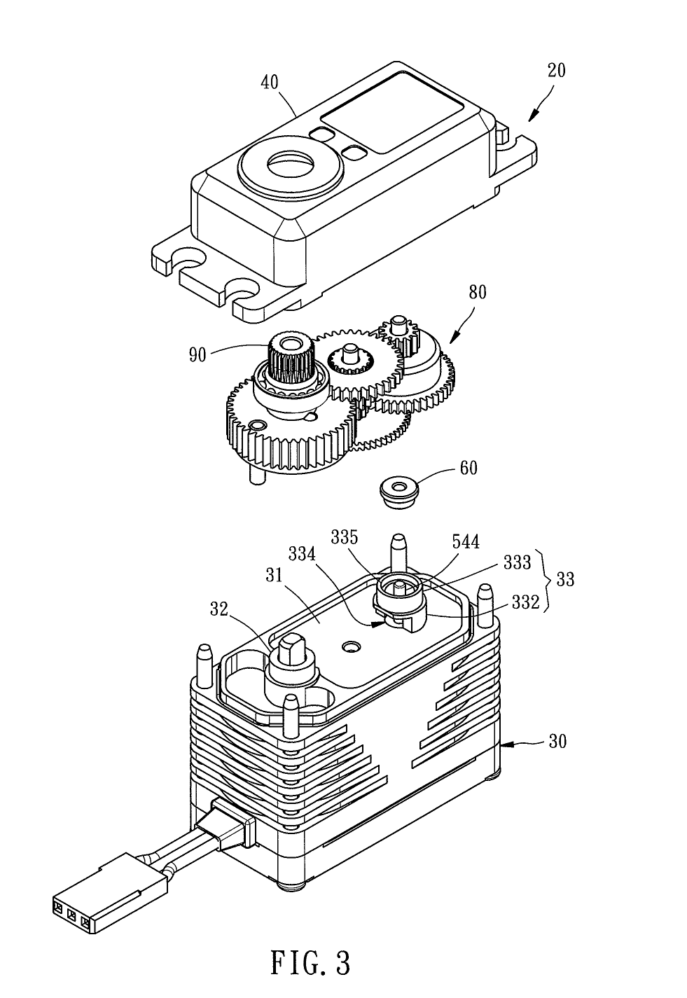

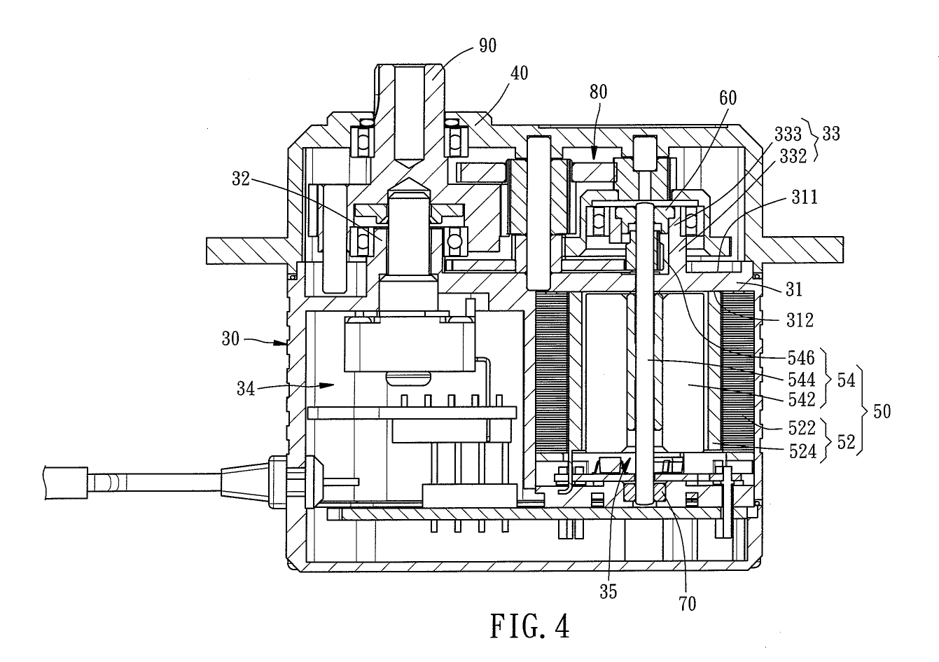

Referring to FIGS. 2-4, a motorized servo device 20 according to a preferred embodiment of the present invention comprises a case 30, a cap 40 which is fixedly mounted on the top of the case 30, a motor 50 and two bearings 60, 70, which are disposed in the case 30, and a transmission mechanism 80 and an output shaft 90, which are disposed in the cap 40.

The case 30 is provided with a top plate 31, two installing seats 32, 33 protruding from a top surface 311 of the top plate 31, and two accommodating spaces 34, 35 located under a bottom surface 312 of the top plate 31 and under the installing seats 32, 33 respectively. The output shaft 90 is rotatably sleeved onto the installing seat 32 and protrudes out of the cap 40. The transmission mechanism 80 is mounted on the installing seat 33 and connected with the output shaft 90.

The improved features of the present invention are related to the installing seat 33, the bearing 60 mounted in the installing seat 33, and the motor 50 and the bearing 70 disposed in the accommodating space 35. The other components and features of the motorized servo device 20 are not quite related to the improved features of the present invention and belong to prior arts and thus not specified hereinafter.

The installing seat 33 has a lower section 332 and an upper section 333. The lower section 332 is located between the top plate 31 and the upper section 333 and shaped like a ring but provided with a side opening 334 toward the installing seat 32. The upper section 333 is shaped like a complete ring and provided with an upward opening 335. The bearing 60 is installed into the upper section 333 through the upward opening 335.

In this embodiment, the motor 50 is a caseless motor which comprises a stator 52 composed of a plurality of annular silicon steel plates 522 and a coil sleeve 524, and a rotor 54 composed of a magnet 542, a spindle 544 and an output gear 546, but doesn't have its own case for accommodating the stator 52 and the rotor 54. The stator 52 and the rotor 54 are directly housed and held by the case 30. The motor 50 is not limited to the caseless motor. However, in the case that the motor 50 is the caseless motor, the motorized servo device 20 will output relatively higher power.

The spindle 544 of the motor 50 penetrates through the top plate 31 of the case 30. The output gear 546 is fixedly sleeved onto the spindle 544 and located in the lower section 332 of the installing seat 33. That is, the output gear 546 is located between the bearing 60 and the top plate 31. Through the side opening 334, the output gear 546 is connected with the transmission mechanism 80. The rotational kinetic energy of the motor 50 is outputted by the output gear 546 and transmitted to the output shaft 90 through the transmission mechanism 80.

The bearings 60, 70 are sleeved onto the spindle 544, located at two ends of the spindle 544 respectively, and relatively fixed to the case 30. Therefore, the bearings 60, 70 can support the spindle 544 and thereby enhance the coaxiality of the rotor 54 of the motor 50, so that the motor 50 rotates relatively more stably. The bearing 60 may, but not limited to, be an anisotropic bearing so as to lower the machining difficulty of the case 30 and enhance the stability of the spindle 544.

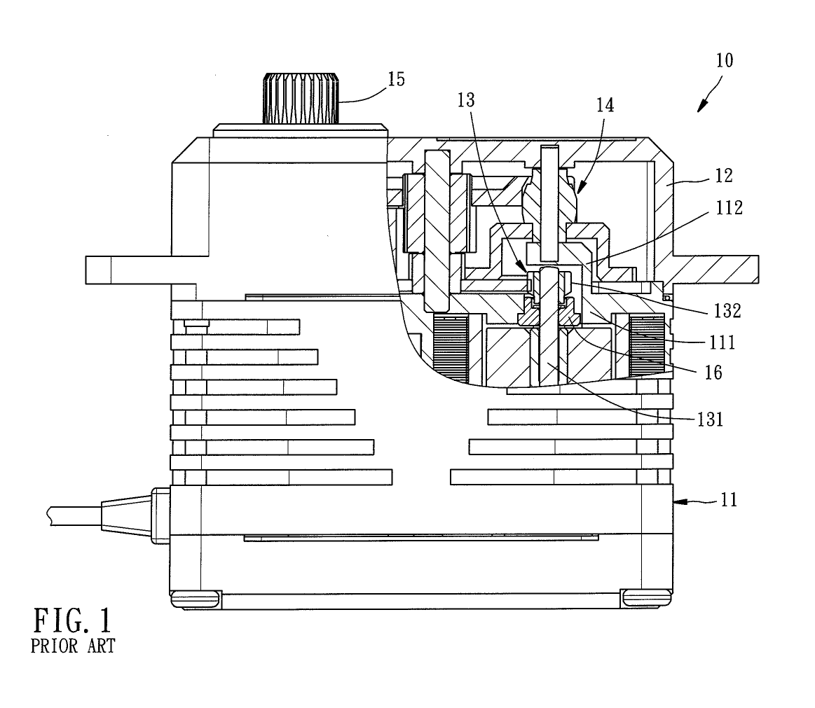

Compared with the aforesaid motorized servo device 10 (shown in FIG. 1) according to the prior art, in the motorized servo device 20 of the present invention, the top plate 31 of the case 30 can be made thinner because the bearing 60 is not mounted in the top plate 31. Since the top plate 31 is thinner, the accommodating space 35 is larger and thereby capable of accommodating larger motor. For example, the motor 50 in this embodiment has longer magnet 542 than the motor 13 of the prior art shown in FIG. 1. Therefore, the motorized servo device 20 of the present invention can output higher power. Besides, in the motorized servo device 20 of the present invention, the bearings 60, 70 supporting two ends of the spindle 544 have a longer distance therebetween, thereby sufficiently enhancing the coaxiality of the rotor 54 and the accuracy of the motor 50. In addition, when the rotor 54 of the motor 50 quakes during running, it will not hit the bearing 60 so that the motorized servo device 20 of the present invention has higher structural reliability. Furthermore, the bearing 60 is more easily installed inside the installing seat 33 through the upward opening 333 so that the process of assembling the motorized servo device 20 is simpler.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A motorized servo device comprising:
a case provided with a top plate having a top surface and a bottom surface, an installing seat protruding from the top surface of the top plate, and an accommodating space located at the bottom surface of the top plate;
a bearing mounted in the installing seat of the case; and
a motor disposed in the accommodating space and provided with a spindle penetrating through the top plate of the case and the bearing.

2. The motorized servo device as claimed in claim 1, wherein the motor further has an output gear sleeved onto the spindle, and located in the installing seat between the bearing and the top plate.

3. The motorized servo device as claimed in claim 1, wherein the installing seat of the case has an upward opening, through which the bearing is mounted in the installing seat.

4. The motorized servo device as claimed in claim 1, wherein the bearing is an anisotropic bearing.

5. The motorized servo device as claimed in claim 1, wherein the motor is a caseless motor.

6. The motorized servo device as claimed in claim 1, wherein the installing seat of the case has an upper section and a lower section; the bearing is mounted in the upper section; the lower section is located between the upper section and the top plate and provided with a side opening.

7. The motorized servo device as claimed in claim 6, wherein the motor further has an output gear sleeved onto the spindle and located in the lower section of the installing seat.

8. The motorized servo device as claimed in claim 6, wherein the upper section of the installing seat has an upward opening, through which the bearing is mounted in the installing seat.
